(19) United States
(12) Patent Application Publication
(10) Pub. No.: US 2026/0338161 A1
(43) Pub. Date: Oct. 29, 2026

(54) WIND TURBINE AND USE OF A POTENTIAL ENERGY STORING DEVICE

(71) Applicant: Joensuun Kauppa ja Kone Oy, Joensuu (FI)

(72) Inventor: Hannu RISSANEN, Helsinki (FI)

(21) Appl. No.: 19/120,410

(22) PCT Filed: Oct. 10, 2023
(86) PCT No.: PCT/FI2023/050577

§ 371 Date: Apr. 11, 2025

(30) Foreign Application Priority Data
Oct. 11, 2022 (FI) 20225918

(51) Int. Cl. F03D 9/13; F03D 3/00; F03D 7/02; F03D 9/25; F03D 13/10; F03D 13/20; F03D 80/80

(52) U.S. Cl. CPC F03D 9/13; F03D 3/005; F03D 7/0204; F03D 9/25; F03D 13/122; F03D 13/20; F03D 13/201; F03D 80/82; F03D 80/88; Y02E 10/74; Y02E 70/30

(57) ABSTRACT

The invention relates to a wind turbine (1) comprising a first wind turbine blade (20) arranged to move around a vertical axis (R) and a first wind turbine blade support (40). The first wind turbine blade support (40) extending between the first wind turbine blade (20) and the wind turbine tower (10).

The wind turbine (1) further comprises an upper support gap (31) arranged to enable a horizontal movement of the first wind turbine blade support (40) in relative to the wind turbine tower (10), and a potential energy storing device (50) arranged to restrain the horizontal movement. The present further relates to use of a potential energy storing device (50) in a wind turbine for restraining a horizontal movement.

### FIELD OF THE INVENTION

The present invention relates to a wind turbine and more particularly to a wind turbine according to preamble of claim 1.

The present invention further relates to use of a potential energy storing device and more particularly to use of a potential energy storing device according to preamble of claim 15.

### BACKGROUND OF THE INVENTION

In the prior art wind turbine blades, which are arranged to move around a vertical axis are connected to a wind turbine tower without a gap such that the wind turbine tower receives directly all forces occurring in a wind turbine blade. Thus, the wind turbine blade causes impacts to a wind turbine tower due to rotation of the wind turbine blade and a direction of a wind.

One of the problems associated with the prior art is that a force of the impacts may compromise the structures of the wind turbine tower, or the wind turbine tower must be extremely heavy.

### BRIEF DESCRIPTION OF THE INVENTION

An object of the present invention is to provide a wind turbine and use of a potential energy storing device so as to solve or at least alleviate the prior art disadvantages.

The objects of the invention are achieved by a wind turbine which is characterized by what is stated in the independent claim 1.

The objects of the invention are further achieved by use of a potential energy storing device which is characterized by what is stated in the independent claim 15.

The preferred embodiments of the invention are disclosed in the dependent claims.

The invention is based on the idea of providing a wind turbine. The wind turbine comprises a wind turbine tower, the wind turbine tower having an upper end and a lower end, and the wind turbine tower extending between the upper end of the wind turbine tower and the lower end of the wind turbine tower. The wind turbine further comprises a first wind turbine blade, the first wind turbine blade is arranged to move around a vertical axis. The wind turbine further comprises a first wind turbine blade support, the first wind turbine blade support extending between the first wind turbine blade and the wind turbine tower, and the first wind turbine blade is fixed to the first wind turbine blade support, or the first wind turbine blade is an integral part of the first wind turbine blade support. The wind turbine further comprises an upper support arrangement provided to the wind turbine tower, the first wind turbine blade support is rotatably supported to the upper support arrangement, the upper support arrangement is arranged to provide the first wind turbine blade support with a support in a vertical direction. The wind turbine further comprises an upper support gap arranged to enable a horizontal movement of the first wind turbine blade support in relative to the wind turbine tower. The wind turbine further comprises a potential energy storing device arranged to restrain a horizontal movement of the first wind turbine blade support and a horizontal movement of the first wind turbine blade.

The potential energy storing device dampens impacts of first wind turbine blade and vibration of the wind turbine tower.

In one embodiment, the wind turbine further comprises a wind turbine generator comprising a first wind turbine generator part and a second wind turbine generator part, and the first wind turbine generator part is arranged to rotate relative to the second wind turbine generator part, and the first wind turbine generator part is arranged to move relative to the upper support arrangement.

This provides electricity generation such that impacts of the first wind turbine blade and other wind turbine blades to the wind power tower are dampen.

In an alternative embodiment, the wind turbine further comprises a wind turbine generator comprising a first wind turbine generator part and a second wind turbine generator part, the first wind turbine generator part is provided above the upper support arrangement, and the first wind turbine generator part is arranged to rotate relative to the second wind turbine generator part, and the first wind turbine generator part is arranged move in a horizontal direction relative to the upper support arrangement and the second wind turbine generator part is arranged to move in the horizontal direction together with the first wind turbine generator part.

This provides electricity generation such that impacts of the first wind turbine blade and other wind turbine blades to the wind power tower are dampen and the first wind turbine generator part is provided with a simple support.

In another alternative embodiment, the wind turbine further comprises a wind turbine generator comprising a first wind turbine generator part and a second wind turbine generator part, the first wind turbine generator part is arranged to rotate relative to the second wind turbine generator part, and the first wind turbine generator part is arranged move in a horizontal direction relative to the upper support arrangement and the second wind turbine generator part is arranged to move in the horizontal direction together with the first wind turbine generator part.

This provides electricity generation such that impacts of the first wind turbine blade and other wind turbine blades to the wind power tower are dampen and the first and the second wind turbine generator part are all the time in a proper position relative to each other.

In one embodiment, the potential energy storing device is rotatably connected to the first wind turbine blade support and the potential energy storing device is mounted to the wind turbine tower.

This dampens impacts between the first wind turbine blade support and the wind turbine tower such that a rotation of the first wind turbine blade and other wind turbine blades is enabled.

In an alternative embodiment, the potential energy storing device extending between the first wind turbine blade support and the wind turbine tower, the potential energy storing device is rotatably connected to the first wind turbine blade support and the potential energy storing device is mounted to the wind turbine tower.

This dampens impacts between the first wind turbine blade support and the wind turbine tower such that a rotation of the first wind turbine blade and other wind turbine blades is enabled.

In another alternative embodiment, the potential energy storing device is rotatably connected to the first wind turbine blade support and the potential energy storing device is fixedly mounted to the wind turbine tower or to the upper support arrangement.

This dampens impacts between the first wind turbine blade support and the wind turbine tower such that a rotation of the first wind turbine blade and other wind turbine blades is enabled.

In a yet another alternative embodiment, the potential energy storing device is connected to the first wind turbine blade support with the second wind turbine generator part, and the potential energy storing device is connected and to the wind turbine tower.

This dampens impacts between the first wind turbine blade support and the wind turbine tower such that a rotation of the first wind turbine blade and other wind turbine blades is enabled.

In a further alternative embodiment, the wind turbine comprises a horizontal support, the first wind turbine blade support is rotatably connected to the horizontal support, the horizontal support is connected to the wind turbine tower with the potential energy storing device.

This dampens impacts between the first wind turbine blade support and the wind turbine tower such that a rotation of the first wind turbine blade and other wind turbine blades is enabled.

In one embodiment, the wind turbine comprises a wind turbine blade counterweight provided to the first wind turbine blade support.

This decreases a bending moment of the wind power tower.

In an alternative embodiment, the wind turbine comprises a wind turbine blade counterweight provided to the first wind turbine blade support, the first wind turbine blade support having a first end and a second end, the first wind turbine blade support extending between the first end and the second end, the first end of the first wind turbine blade support is provided at a first side of the wind turbine tower and the second end of the first wind turbine blade support is provided at a second side of the wind turbine tower, the first wind turbine blade is provided at a first side of the wind turbine tower and wind turbine blade counterweight is provided at a second side of the wind turbine tower.

This decreases a bending moment of the wind power tower.

In another alternative embodiment, the wind turbine comprises a second wind turbine blades provided to the first wind turbine blade support, the first wind turbine blade support extending between the first wind turbine blade and the second wind turbine blade, and the first wind turbine blade support extending between the second wind turbine blade and the wind turbine tower.

This decreases a bending moment of the wind power tower, but this increases a force of the impact cause the first and the second wind turbine blade.

In a yet another alternative embodiment, the wind turbine comprises one or more second wind turbine blade supports and one or more second wind turbine blades, the one or more second wind turbine blades are provided to the one or more second wind turbine blade supports, the one or more second wind turbine blade supports extending between the one or more second wind turbine blades and the wind turbine tower, the one or more second wind turbine blades are arranged to move around a vertical axis, and the one or more second wind turbine blade supports are supported in a vertical direction to the upper support arrangement.

This decreases a bending moment of the wind power tower and efficiency of the wind turbine.

In a yet another further alternative embodiment, the blades of wind turbine consist of the first wind turbine blade.

This improves efficiency of the wind turbine.

In a yet alternative embodiment, the wind turbine comprises a wind turbine blade counterweight provided to the first wind turbine blade support and the blades of wind turbine consist of the first wind turbine blade.

This improves efficiency of the wind turbine and balance weight of the first wind turbine blade.

In one embodiment, the wind turbine comprises a universal joint, the universal joint is arranged to prevent a rotational movement of the second wind turbine generator part relative to the first wind turbine generator part.

The universal joint provides a simple structure to prevent a rotational movement of the second wind turbine generator part relative to the first wind turbine generator part.

In an alternative embodiment, the wind turbine comprises a lower support arrangement provided to the wind turbine tower below the upper support arrangement, the lower support arrangement being stationary relative to the wind turbine tower, the wind turbine comprises a universal joint, the universal joint having a lower end and an upper end, the lower end of the universal joint is mounted to the lower support arrangement and the upper end of the universal joint is connected to the second wind turbine generator part.

The universal joint provides a simple structure to prevent a rotational movement of the second wind turbine generator part relative to the first wind turbine generator part.

In another alternative embodiment, the wind turbine comprises a lower support arrangement provided to the wind turbine tower below the upper support arrangement, the lower support arrangement being stationary relative to the wind turbine tower, the wind turbine comprises a universal joint, the universal joint having a lower end and an upper end, the lower end of the universal joint is mounted to the lower support arrangement and the upper end of the universal joint is mounted to the second wind turbine generator part, the universal joint is arranged to prevent a rotational movement of the second wind turbine generator part relative to the first wind turbine generator part.

The universal joint provides a simple structure to prevent a rotational movement of the second wind turbine generator part relative to the first wind turbine generator part.

In a yet another alternative embodiment, the wind turbine comprises a lower support arrangement provided to the wind turbine tower below the upper support arrangement, the lower support arrangement being stationary relative to the wind turbine tower, the wind turbine comprises a universal joint, the universal joint having a lower end and an upper end, the lower end of the universal joint is mounted to the lower support arrangement or to the wind turbine tower, the upper end of the universal joint is mounted to a horizontal support, and the universal joint is arranged to prevent a rotational movement of the second wind turbine generator part relative to the first wind turbine generator part.

The universal joint provides a simple structure to prevent a rotational movement of the second wind turbine generator part relative to the first wind turbine generator part.

In one embodiment, the potential energy storing device comprises three or more the potential energy storing elements.

This provides sufficient dampening of the impacts.

In an alternative embodiment, the potential energy storing device comprises three potential energy storing elements.

This restrains horizontal movement in all horizontal directions.

In another alternative embodiment, the potential energy storing device comprises three or more potential energy storing elements, the three or more potential energy storing elements having a first end and a second end, the first end of the energy storing elements is fixedly connected to wind tower and the second end of the energy storing elements is rotatably connected to the first wind turbine blade, and the first end of the energy storing elements being above the second end of the energy storing elements.

This enables dampening of the impacts of the first wind turbine blade and other wind turbine blades such that dampening does not affect to a rotation of the first wind turbine blade and other wind turbine blades.

In a yet another alternative embodiment, the potential energy storing device comprises three potential energy storing elements, a horizontal angle in a horizontal direction between the adjacent potential energy storing elements being 120 degrees.

This restrains horizontal movement in all horizontal directions.

In a further another alternative embodiment, the potential energy storing device comprises three or more the potential energy storing elements, a horizontal angle in a horizontal direction between the adjacent potential energy storing elements being in the range of 0 and 120 degrees.

This restrains horizontal movement in all horizontal directions.

In a further another alternative embodiment, the potential energy storing device comprises three or more the potential energy storing elements, a horizontal angle in a horizontal direction between the adjacent potential energy storing elements being in the range of 10 and 120 degrees.

This restrains horizontal movement in all horizontal directions.

In one embodiment, the potential energy storing element comprises a pulley, a rope, and a weight.

These are suitable for dampening the impacts of the wind turbine blades.

In an alternative embodiment, the potential energy storing element comprises a spring.

A spring is a simple struct as a potential energy storing element.

In another alternative embodiment, the potential energy storing element comprises a tension spring.

In a yet another alternative embodiment, the potential energy storing element comprises a compression spring.

In a further alternative embodiment, the potential energy storing element comprises an elastic object.

In a yet further alternative embodiment, the potential energy storing element comprises a magnetic field.

In a yet another further alternative embodiment, the potential energy storing element comprises a device filled with gas.

In one embodiment, the potential energy storing device is arranged to restrain a horizontal movement of the first wind turbine blade support and a horizontal movement of the first wind turbine blade and the potential energy storing device is arranged further to restrain a vertical movement of the first wind turbine blade support and the first wind turbine blade.

This prevents the first wind turbine blade moving upwards.

In an alternative embodiment, the potential energy storing device is arranged to restrain a horizontal movement of the first wind turbine blade support and the first wind turbine blade and the potential energy storing device is arranged further to restrain a vertical movement of the first wind turbine blade support and the first wind turbine blade, and the potential energy storing device extending transverse relative to a horizontal direction and transverse relative to a vertical direction.

This prevents the first wind turbine blade moving upwards.

In another alternative embodiment, the potential energy storing device is arranged to restrain a horizontal movement of the first wind turbine blade support and the first wind turbine blade and the potential energy storing device is arranged further to provide an upward vertical force to the first wind turbine blade support or to the a wind turbine generator, and the first wind turbine blade, and the potential energy storing device extending transverse relative to a horizontal direction and transverse relative to a vertical direction.

This decreases a friction and thus, improves efficiency of the wind turbine.

In a yet alternative embodiment. the potential energy storing device is arranged to restrain a horizontal movement of the first wind turbine blade support and the first wind turbine blade, the potential energy storing device is arranged further to provide an upward vertical force, and the first wind turbine blade, and the potential energy storing device extending transverse relative to a horizontal direction and transverse relative to a vertical direction.

This decreases a friction and thus, improves efficiency of the wind turbine.

In one embodiment, the potential energy storing elements having a first end and a second end, the first end of the energy storing elements is fixedly connected to wind tower and the second end of the energy storing elements is rotatably connected to the first wind turbine blade, and the first end of the energy storing elements being above the second end of the energy storing element, and the potential energy storing device comprises a spring arranged to provide an upward vertical force.

This decreases a friction and thus, improves efficiency of the wind turbine.

In an alternative embodiment, the potential energy storing elements having a first end and a second end, the first end of the energy storing elements is fixedly connected to wind tower and the second end of the energy storing elements is rotatably connected to the first wind turbine blade, and the first end of the energy storing elements being below the second end of the energy storing element, and the potential energy storing device comprises a spring arranged to provide an upward vertical force.

This decreases a friction and thus, improves efficiency of the wind turbine.

In one embodiment, the wind turbine tower comprises a lattice column.

A lattice column is a light and strong structure.

In an alternative embodiment, the wind turbine tower comprises a tubular column.

A tubular column is a strong structure.

In another alternative embodiment, the wind turbine tower comprises a lattice column and three or more guy-ropes.

The three or more guy-ropes increase stiffness of the wind turbine tower.

In a yet alternative embodiment, the wind turbine tower comprises a tubular column and three or more guy-ropes.

In one embodiment, the upper support arrangement is provided to the upper end of the wind turbine tower or in the vicinity of the upper end of the wind turbine tower.

This provides a simple structure for supporting rotatable the first wind turbine blade support.

In an alternative embodiment, the upper support arrangement is provided to the upper end of the wind turbine tower or in the vicinity of the upper end of the wind turbine tower, and the first wind turbine blade support is arranged to move above the upper end of the wind turbine tower and above the upper support arrangement.

This provides a simple structure for supporting rotatable the first wind turbine blade support.

In another alternative embodiment, the upper support arrangement is provided to the upper end of the wind turbine tower or in the vicinity of the upper end of the wind turbine tower, and the first wind turbine blade support and the one or more second wind turbine blade supports are arranged to move above the upper end of the wind turbine tower and above the upper support arrangement.

This provides a simple structure for supporting rotatable the first wind turbine blade support.

In one embodiment, the wind turbine comprises a friction reducing part between the first wind turbine blade support and the upper support arrangement, friction reducing part is arranged to reduce friction of a support of the first wind turbine blade support in a vertical direction.

This improves efficiency of the wind turbine.

In an alternative embodiment, the wind turbine comprises a rolling bearing between the first wind turbine blade support and the upper support arrangement.

This further improves efficiency of the wind turbine.

In another alternative embodiment, the wind turbine comprises a rolling bearing between the first wind turbine blade support and the upper support arrangement, and the rolling bearing comprises one or more balls or rollers.

This further improves efficiency of the wind turbine.

In a yet another alternative embodiment, the wind turbine comprises a rolling bearing between the first wind turbine blade support and the upper support arrangement, and the rolling bearing comprises three or more balls or rollers.

This further improves efficiency of the wind turbine such that the first wind turbine blade support being balanced.

In a further alternative embodiment, the wind turbine two sliding surfaces between the first wind turbine blade support and the upper support arrangement.

This is a simple and balanced structure for decreasing friction.

In one embodiment, the wind turbine tower comprises a securing element arranged to restrict a vertical movement of the first wind turbine blade support.

The securing element is arranged to secure the first wind turbine blade support during lifting and during unexpected movement.

In an alternative embodiment, the wind turbine tower comprises a securing element arranged to restrict a horizontal movement of the first wind turbine blade support.

In another alternative embodiment, the wind turbine tower comprises a securing element arranged to restrict a vertical movement and a horizontal movement of the first wind turbine blade support.

In a further alternative embodiment, the wind turbine tower comprises a securing element arranged to restrict a vertical movement and a horizontal movement of the first wind turbine blade support, the securing element is provided above the upper surface of the upper support arrangement.

In one embodiment, the wind turbine comprises the first wind turbine generator part, the first wind turbine blade support, the first wind turbine blade, and wind turbine blade counterweight arranged to move around a vertical axis, and a total weight of the first wind turbine generator part, the first wind turbine blade support, the first wind turbine blade and wind turbine blade counterweight being in the range of 400 kg-800 kg or 400-10 000 kg.

This weight may be reasonably dampened.

In an alternative embodiment, the upper support gap being in the range of 10 mm-150 mm or in the range of 75 mm-150 mm or in the range of 5 mm-300 mm or more than 5 mm.

This enables enough gap for the horizontal movement.

In another alternative embodiment, the wind turbine comprises the first wind turbine generator part, the first wind turbine blade support, the first wind turbine blade, and wind turbine blade counterweight arranged to move around a vertical axis, and a total weight the first wind turbine generator part, the first wind turbine blade support, the first wind turbine blade and wind turbine blade counterweight being in the range of 400 kg-800 kg or 400-10 000 kg, and the upper support gap being in the range of 10 mm-150 mm or in the range of 75 mm-150 mm or in the range of 5 mm-300 mm or more than 5 mm.

This weight may be dampened such that impacts may be successfully dampened.

In one embodiment, the wind turbine comprises a horizontal support, the first wind turbine blade support is rotatably connected to the horizontal support, the horizontal support is connected to the wind turbine tower with the potential energy storing device, the upper support arrangement comprises an upper surface and a lower surface, the upper surface of the upper support arrangement being above the lower surface of the upper support arrangement, the upper support arrangement comprises an upper support opening, the upper support opening extending from the upper surface of the upper support arrangement to the lower surface of the upper support arrangement, horizontal support extending through the upper support opening.

In an alternative embodiment, the wind turbine comprises a horizontal support, the first wind turbine blade support is rotatably connected to the horizontal support, the horizontal support is connected to the wind turbine tower with the potential energy storing device, the upper support arrangement comprises an upper surface and a lower surface, the upper surface of the upper support arrangement being above the lower surface of the upper support arrangement, the upper support arrangement comprises an upper support opening, the upper support opening extending from the upper surface of the upper support arrangement to the lower surface of the upper support arrangement, the horizontal support extending through the upper support opening.

In another alternative embodiment, the wind turbine comprises a horizontal support, the first wind turbine blade support is rotatably connected to the horizontal support, the horizontal support is connected to the wind turbine tower with the potential energy storing device, the upper support arrangement comprises an upper surface and a lower surface, the upper surface of the upper support arrangement being above the lower surface of the upper support arrangement, the upper support arrangement comprises an upper support opening, the upper support opening extending from the upper surface of the upper support arrangement to the lower surface of the upper support arrangement, the horizontal support extending through the upper support opening, the second wind turbine generator part is fixedly connected to the horizontal support and the first wind turbine generator part is fixedly connected to the first wind turbine blade support or to the first wind turbine blade support and to the one or more second wind turbine blade support.

In a yet another alternative embodiment, the wind turbine comprises a horizontal support, the first wind turbine blade support is rotatably connected to the horizontal support, the horizontal support is connected to the wind turbine tower with the potential energy storing device, the upper support arrangement comprises an upper surface and a lower surface, the upper surface of the upper support arrangement being above the lower surface of the upper support arrangement, the upper support arrangement comprises an upper support opening, the upper support opening extending from the upper surface of the upper support arrangement to the lower surface of the upper support arrangement, the horizontal support extending through the upper support opening, the second wind turbine generator part is fixedly connected to the horizontal support and the first wind turbine generator part is fixedly connected to the first wind turbine blade support or to the first wind turbine blade support and to the one or more second wind turbine blade support, the upper support opening comprises a circular surface facing towards the horizontal support, upper support gap is provided between the upper support arrangement and the horizontal support, and the horizontal support comprises a circular outer surface arranged to face towards the upper support gap. The universal joint is mounted to the horizontal support and to the wind turbine tower or the lower support arrangement.

This provides a simple structure such that the potential energy storing device dampens impacts of the blades and vibrations caused by the impacts.

The present invention further relates to use of a potential energy storing device in a wind turbine for restraining a horizontal movement of the first wind turbine blade support and a horizontal movement of the first wind turbine blade fixed to the first wind turbine blade support. The first wind turbine blade is arranged to move around a vertical axis.

The potential energy storing device dampens impacts of the blades and vibrations caused by the impacts.

In one embodiment, the wind turbine being any above disclosed embodiment of the wind turbine.

An advantage of the invention is that light structures may be used in wind turbine towers as impacts of the wind turbine blade are decreased.

Furthermore, a vibration of a wind power tower is dampened.

Furthermore, rotational friction in the wind turbine may be reduced and thus, efficiency of the wind power turbine may be increased.

### BRIEF DESCRIPTION OF THE DRAWINGS

The invention is described in detail by means of specific embodiments with reference to the enclosed drawings, in which

FIG. 1 shows schematically a side view of a wind turbine according to one embodiment to the present invention;

FIG. 2 shows schematically a top view of the wind turbine of FIG. 1;

FIGS. 3-5 show schematically a side view of a wind turbine according to different embodiment to the present invention.

### DETAILED DESCRIPTION OF THE INVENTION

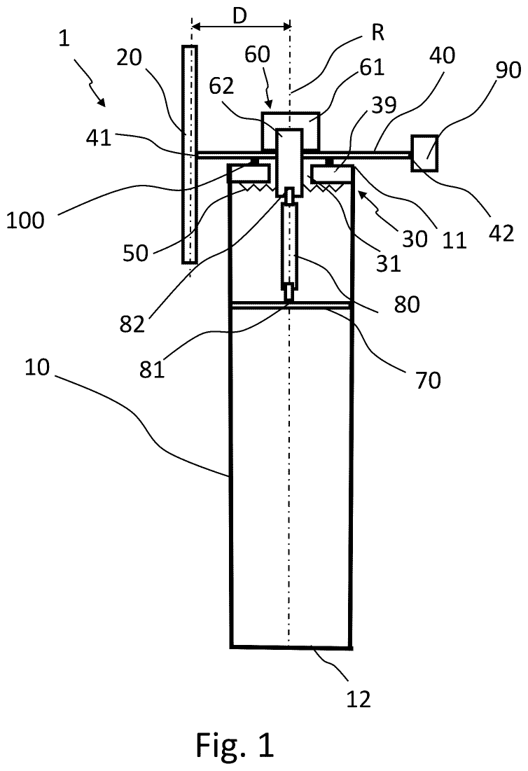

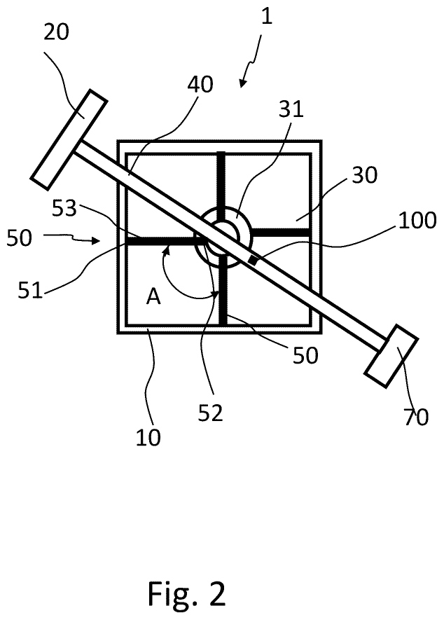

FIG. 1 and FIG. 2 show schematically one embodiment of a wind turbine 1 according to the present invention. The wind turbine 1 is a device that converts the kinetic energy of wind into electrical energy.

The wind turbine 1 comprises a wind turbine tower 10. The wind turbine tower 10 having an upper end 11 and a lower end 12, and the wind turbine tower extending between the upper end 11 of the wind turbine tower 10 and the lower end 12 of the wind turbine tower 10.

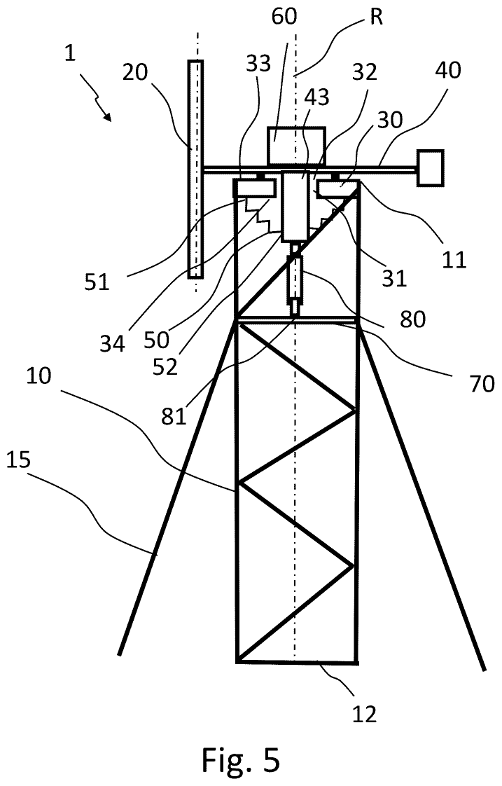

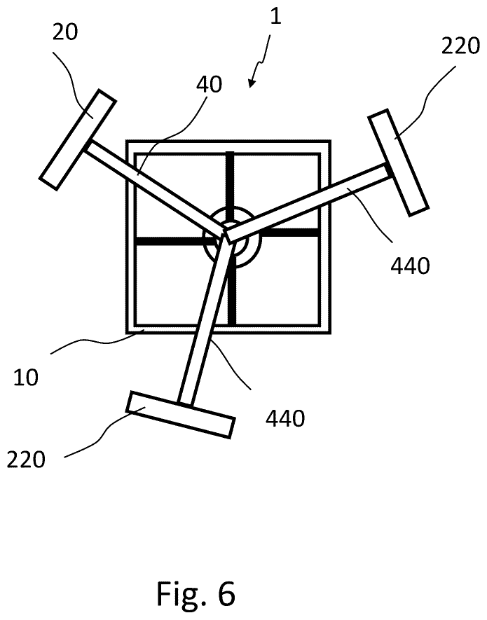

In one embodiment, the wind turbine tower 10 comprises a lattice column. The lattice column is shown in FIG. 5

In an alternative embodiment, the wind turbine tower 10 comprises a tubular column.

In one embodiment, the wind turbine tower 10 comprises a lattice column and three or more guy-ropes 15. This is shown in FIG. 5

In an alternative embodiment, the wind turbine tower 10 comprises a tubular column and three or more guy-ropes 15.

The three or more guy-ropes 15 are tensioned cables designed to add stability to the wind turbine 1. One end of the three or more guy-ropes 15 are connected the wind turbine tower 10, and the other is anchored to the ground at some distance from the wind turbine tower 10.

The tension in the diagonal guywire, combined with the compression and buckling strength of the wind turbine tower 10, allows the wind turbine 1 to withstand more lateral loads such as wind or the weight of cantilevered structures. They are installed radially, usually at equal angles about the structure, in trios and quads.

The wind turbine 1 further comprises a first wind turbine blade 20, the first wind turbine blade 20 is arranged to move around a vertical axis R.

In the context of this application the vertical axis means an axis such an angle between the axis and a horizontal direction being between 85 degrees-95 degrees.

The first wind turbine blade 20 converting wind energy to low-speed rotational energy.

The wind turbine 1 further comprises a first wind turbine blade support 40. The first wind turbine blade support 40 extending between the first wind turbine blade 20 and the wind turbine tower 10, and the first wind turbine blade 20 is fixed to the first wind turbine blade support 40 or the first wind turbine blade 20 is an integral part of the first wind turbine blade support 40.

In the context of this application, extending means arranged to extend.

In the context of this application, the first wind turbine blade support 40 extending between the first wind turbine blade 20 and the wind turbine tower 10 means that at least a part of the first wind turbine blade support 40 is positioned between the first wind turbine blade 20 and the wind turbine tower 10.

The wind turbine 1 further comprises an upper support arrangement 30 provided to the wind turbine tower 10, the first wind turbine blade support 40 is rotatably supported to the upper support arrangement 30, the upper support arrangement 30 is arranged to provide the first wind turbine blade support 40 with a support in a vertical direction.

In other words, the first wind turbine blade support 40 is arranged to move around a vertical axis R and move in a horizontal direction.

In one embodiment, the upper support arrangement 30 is provided to the upper end 11 of the wind turbine tower 10 or in the vicinity of the upper end 11 of the wind turbine tower 10.

In one embodiment, the first wind turbine blade support 40 is arranged to move above the upper end 11 of the wind turbine tower 10 and above the upper support arrangement 30.

In one embodiment, the upper support arrangement 30 is provided to the upper end 11 of the wind turbine tower 10 or in the vicinity of the upper end 11 of the wind turbine tower 10, and the first wind turbine blade support 40 and the one or more second wind turbine blade supports 440 are arranged to move above the upper end 11 of the wind turbine tower 10 and above the upper support arrangement 30.

The one or more second wind turbine blade supports 440 are shown in FIG. 6

In one embodiment, the upper support arrangement 30 comprises an upper support plate 39. The upper support plate 39 comprises the upper surface 33 of the upper support arrangement 30. The upper surface 33 of the upper support arrangement 30 is arranged to extend in a horizontal direction.

In the context of this application the horizontal direction means a direction such an angle between the direction and an upright direction being between 85 degrees-95 degrees.

The wind turbine 1 further comprises an upper support gap 31 arranged to enable a horizontal movement of the first wind turbine blade support 40 in relative to the wind turbine tower 10.

The first wind turbine blade 20 is arranged to move together with the first wind turbine blade support 40.

In one embodiment, the upper support gap 31 extending in a horizontal direction as shown in FIG. 1.

In other words, the upper support gap 31 being a gap between two surfaces extending transversely in relative to a horizontal direction.

In alternative embodiment, the upper support gap 31 extending in a vertical direction.

In other words, the upper support gap 31 being a gap between two surfaces extending transversely in relative to a vertical direction. This further means that in this embodiment, the wind turbine 1 further comprises a vertical support part which extends in a vertical direction and being flexible in a horizontal direction.

In preferred embodiment, the first wind turbine blade 20, the first wind turbine blade support 40, a wind turbine generator 60 comprising a first wind turbine generator part 61 and a second wind turbine generator part 62 are arranged to move together in a horizontal direction. In one embodiment, the upper support gap 31 comprises elastic material such that the horizontal movement being enabled.

The wind turbine 1 further comprises a potential energy storing device 50 arranged to restrain a horizontal movement of the first wind turbine blade support 40 and a horizontal movement of the first wind turbine blade 20.

In the context of this application, potential energy is the energy held by an object because of its position relative to other objects or stresses within itself.

In one embodiment, the potential energy storing device having gravitational potential energy depending on its mass and its distance from the centre of mass of another object or an elastic potential energy of an extended spring or an elastic potential energy.

In a preferred embodiment, the potential energy storing device having an elastic potential energy of an extended spring.

In one embodiment, the potential energy storing element 53 comprises a pulley, a rope, and a weight.

In one embodiment, the potential energy storing element 53 comprises a spring.

In one embodiment, the potential energy storing element 53 comprises a tension spring; or

In one embodiment, the potential energy storing element 53 comprises a compression spring.

A spring is an elastic object that stores mechanical energy. Springs are typically made of spring steel. There are many spring designs. In everyday use, the term often refers to coil springs.

When a conventional spring, without stiffness variability features, is compressed or stretched from its resting position, it exerts an opposing force approximately proportional to its change in length (this approximation breaks down for larger deflections). The rate or spring constant of a spring is the change in the force it exerts, divided by the change in deflection of the spring. That is, it is the gradient of the force versus deflection curve. An extension or compression spring's rate is expressed in units of force divided by distance, for example or N/m.

In one embodiment, the potential energy storing element 53 comprises an elastic object.

In one embodiment, the wind turbine 1 comprises a wind turbine blade counterweight 90 provided to the first wind turbine blade support 40.

The wind turbine blade counterweight 90 being a weight that balances a weight of the first wind turbine blade support 40. In other words, the wind turbine blade counterweight 90 provides balance to the first wind turbine blade support 40 or increase balance of the first wind turbine blade support 40.

In one embodiment, the first wind turbine blade support 40 having a first end 41 and a second end 42, the first wind turbine blade support 40 extending between the first end 41 and the second end 42, the first end 41 of the first wind turbine blade support 40 is provided at a first side of the wind turbine tower 10 and the second end 42 of the first wind turbine blade support 40 is provided at a second side of the wind turbine tower 10, the first wind turbine blade 20 is provided at a first side of the wind turbine tower 10 and wind turbine blade counterweight 90 is provided at a second side of the wind turbine tower 10.

In an alternative embodiment the wind turbine 1 comprises a second wind turbine blades 220 provided to the first wind turbine blade support 40, the first wind turbine blade support 40 extending between the first wind turbine blade 20 and the second wind turbine blade 220, and the first wind turbine blade support 40 extending between the second wind turbine blade 220 and the wind turbine tower 10.

In other words, a second wind turbine blade 220 and a first wind turbine blade 20 are fixed to the first wind turbine blade support 40 or a second wind turbine blade 220, the first wind turbine blade 20 the first wind turbine blade support 40 are arranged to form one integral part Not shown in figures.

In another alternative embodiment, the wind turbine 1 comprises one or more second wind turbine blade supports 40 and one or more second wind turbine blades 220, the one or more second wind turbine blades 220 are provided to the one or more second wind turbine blade supports 440, the one or more second wind turbine blade supports 440 extending between the one or more second wind turbine blades and the wind turbine tower 10, the one or more second wind turbine blades 220 are arranged to move around a vertical axis R, and the one or more second wind turbine blade supports 440 are supported in a vertical direction to the upper support arrangement 30.

The one or more second wind turbine blades 220 and the one or more second wind turbine blade supports 440 are shown in FIG. 6. It should be noted that all embodiments shown in FIGS. 1-5 may comprise the one or more second wind turbine blades 220 and the one or more second wind turbine blade supports 440.

In one embodiment, the first wind turbine blade 20 and the second wind turbine blade 220 being a helical rotor.

In an alternative embodiment, the first wind turbine blade 20 and the second wind turbine blade 220 being a vertical spiral rotor.

In one embodiment, the first wind turbine blade being a helical rotor.

In an alternative embodiment, the first wind turbine blade 20 being a vertical spiral rotor.

In one embodiment, the wind turbine 1 further comprises a wind turbine generator 60 comprising a first wind turbine generator part 61 and a second wind turbine generator part 62, and the first wind turbine generator part 61 is arranged to rotate relative to the second wind turbine generator part 62, and the first wind turbine generator part 61 is arranged to move relative to the upper support arrangement 30.

The wind turbine generator 60 is a device that converts motive power (mechanical energy) into electric power. The mechanical energy forces a generator to rotate.

Typically, generating electricity and is based on Faraday's law such that a magnet rotating within closed loops of conducting material (e.g., copper wire). Almost all commercial electrical generation is done using electromagnetic induction.

In one embodiment, the first wind turbine generator part 61 is provided above the upper support arrangement 30, and the first wind turbine generator part 61 is arranged to rotate relative to the second wind turbine generator part 62, and the first wind turbine generator part 61 is arranged move in a horizontal direction relative to the upper support arrangement 30 and the second wind turbine generator part 62 is arranged to move in the horizontal direction together with the first wind turbine generator part 61.

In one embodiment, the wind turbine 1 further comprises a wind turbine generator 60 comprising a first wind turbine generator part 61 and a second wind turbine generator part 62, the first wind turbine generator part 61 is arranged to rotate relative to the second wind turbine generator part 62, and the first wind turbine generator part 61 is arranged move in a horizontal direction relative to the upper support arrangement 30 and the second wind turbine generator part 62 is arranged to move in the horizontal direction together with the first wind turbine generator part 61.

In one embodiment, the second wind turbine generator part 62, the first wind turbine generator part 61 and the first wind turbine blade support 40 are arranged to move together in the horizontal direction.

In one embodiment, the second wind turbine generator part 62, the first wind turbine generator part 61, the first wind turbine blade support 40 and a one or more second wind turbine blade supports 440 are arranged to move together in the horizontal direction.

In one embodiment, the wind turbine 1 comprises a universal joint 80, the universal joint 80 is arranged to prevent a rotational movement of the second wind turbine generator part 62 relative to the first wind turbine generator part 61.

In one embodiment, the wind turbine 1 comprises a lower support arrangement 70 provided to the wind turbine tower 10 below the upper support arrangement 30, the lower support arrangement being stationary relative to the wind turbine tower 10, the wind turbine 1 comprises a universal joint 80, the universal joint 80 having a lower end 81 and an upper end 82, the lower end 81 of the universal joint 80 is mounted to the lower support arrangement 70 and the upper end 82 of the universal joint 80 is connected to the second wind turbine generator part 62.

In one embodiment, the wind turbine 1 comprises a lower support arrangement 70 provided to the wind turbine tower 10 below the upper support arrangement 30, the lower support arrangement being stationary relative to the wind turbine tower 10, the wind turbine 1 comprises a universal joint 80, the universal joint 80 having a lower end 81 and an upper end 82, the lower end 81 of the universal joint 80 is mounted to the lower support arrangement 70 and the upper end 82 of the universal joint 80 is mounted to the second wind turbine generator part 62, the universal joint 80 is arranged to prevent a rotational movement of the second wind turbine generator part 62 relative to the first wind turbine generator part 61.

In one embodiment, the wind turbine 1 comprises a lower support arrangement 70 provided to the wind turbine tower 10 below the upper support arrangement 30, the lower support arrangement being stationary relative to the wind turbine tower 10, the wind turbine 1 comprises a universal joint 80, the universal joint 80 having a lower end 81 and an upper end 82, the lower end 81 of the universal joint 80 is mounted to the lower support arrangement 70 or to the wind turbine tower 10, the upper end 82 of the universal joint 80 is mounted to a horizontal support 43, and the universal joint 80 is arranged to prevent a rotational movement of the second wind turbine generator part 62 relative to the first wind turbine generator part 61.

In one embodiment, the second wind turbine generator part 62 comprises a wind turbine generator axis and an armature. The first wind turbine generator part 61 is provided around the armature of the second wind turbine part and the wind turbine generator axis of the second wind turbine generator part 62 downwards. In one embodiment, the universal joint 80 comprises a first pair of hinges located close together and oriented at 90° to each other, a second pair of hinges located close together and oriented at 90° to each other and a cross shaft arranged to connect the first pair of hinges and the second pair of hinges.

In one embodiment, the first pair of hinges of the universal joint 80 is provided to the lower end 81 of the universal joint 80 and the second pair of hinges of the universal joint 80 is provided to the upper end 82 of the universal joint 80.

The universal joint is commonly used in shafts that transmit rotary motion. Surprisingly, in the present application the universal joint 80 prevent rotary motion of the second wind turbine generator part 62 relative to the first wind turbine generator part 61 so that the first wind turbine generator part 61 and the second wind turbine generator part 62 are enabled to move in any horizontal direction together.

In one embodiment, the second wind turbine generator part 62 comprises a wind turbine generator axis and an armature. The first wind turbine generator part 61 is provided around the armature of the second wind turbine part and the wind turbine generator axis of the second wind turbine generator part 62 downwards, and the universal joint 80 is connected to the wind turbine generator axis.

In one embodiment, the second wind turbine generator part 62 comprises a wind turbine generator axis and an armature. The first wind turbine generator part 61 is provided around the armature of the second wind turbine part and the wind turbine generator axis of the second wind turbine generator part 62 downwards, and the universal joint 80 is connected to the wind turbine generator axis below the upper support arrangement 30

In one embodiment, the wind turbine 1 comprises a friction reducing part between the first wind turbine blade support 40 and the upper support arrangement 30, friction reducing part is arranged to reduce friction of a support of the first wind turbine blade support 40 in a vertical direction; or

In one embodiment, the wind turbine 1 comprises a rolling bearing 100 between the first wind turbine blade support 40 and the upper support arrangement 30.

In one embodiment, a friction reducing part comprises the rolling bearing 100.

In one embodiment, a friction reducing part comprises the rolling bearing 100 comprising two layers of balls.

In one embodiment, a friction reducing part comprises the rolling bearing 100 comprising two layers of balls, a lower layer comprises three or more first balls, and an upper layer comprises one second ball. The first balls are arranged to support the second ball.

In one embodiment, the rolling bearing 100 comprises one or more balls or rollers.

In one embodiment, the rolling bearing 100 comprises three or more balls or rollers.

In one embodiment, the wind turbine 1 two sliding surfaces between the first wind turbine blade support 40 and the upper support arrangement 30.

A bearing is a machine element that constrains relative motion to only the desired motion and reduces friction between moving parts.

In one embodiment, the rolling bearing 100 comprises spherical balls.

In one embodiment, the rolling bearing 100 comprises are cylindrical rollers, linearly tapered (conical) rollers, or rollers with a curved taper (so-called spherical rollers).

In one embodiment, the wind turbine 1 comprises the first wind turbine generator part 61, the first wind turbine blade support 40, the first wind turbine blade 20, and wind turbine blade counterweight 90 arranged to move around a vertical axis R, and a total weight of the wind turbine 1 comprises the first wind turbine generator part 61, the first wind turbine blade support 40, the first wind turbine blade 20 and wind turbine blade counterweight 90 being in the range of 400 kg-800 kg or 400-10 000 kg

In one embodiment, the upper support gap 31 being in the range of 10 mm-150 mm or in the range of 75 mm-150 mm or in the range of 5 mm-300 mm or more than 5 mm.

In one embodiment, the potential energy storing device 50 is rotatably connected to the first wind turbine blade support 40 and the potential energy storing device 50 is mounted to the wind turbine tower 10.

In one embodiment, the potential energy storing device 50 is rotatably connected to the first wind turbine blade support 40 and the potential energy storing device 50 is mounted to the wind turbine tower 10, the potential energy storing device 50 comprises one or more potential energy storing elements 53 having a first end 51 and a second end 52, the first end 51 of the one or more potential energy storing elements 53 is mounted to the wind turbine tower 10 and the second end 51 of the one or more potential energy storing elements 53 is rotatably connected to the first wind turbine blade support 40.

In one embodiment, the potential energy storing device 50 is rotatably connected to the first wind turbine blade support 40 and the potential energy storing device 50 is mounted to the wind turbine tower 10, the potential energy storing device 50 comprises one or more potential energy storing elements 53 having a first end 51 and a second end 52, the first end 51 of the one or more potential energy storing elements 53 is connected to the wind turbine tower 10 and the second end 51 of the one or more potential energy storing elements 53 is rotatably connected to the first wind turbine blade support 40.

The one or more potential energy storing elements 53 having a first end 51 and a second end 52 are shown in FIG. 5.

In one embodiment, the first end 51 of the energy storing elements 53 is fixedly connected to wind tower 10 and second end 52 of the energy storing elements 53 is rotatably connected to the first wind turbine blade 20.

In the context of this application connected means is that a part is directly mounted or fixed to other part or that a part is mounted or fixed to other part with another part.

In one embodiment, the potential energy storing device 50 extending between the first wind turbine blade support 40 and the wind turbine tower 10, the potential energy storing device 50 is rotatably connected to the first wind turbine blade support 40 and the potential energy storing device 50 is mounted to the wind turbine tower 10.

In one embodiment, the potential energy storing device 50 extending between the first wind turbine blade support 40 and the wind turbine tower 10, the potential energy storing device 50 is rotatably connected to the first wind turbine blade support 40 and the potential energy storing device 50 is fixedly mounted to the wind turbine tower 1 or to the upper support arrangement 30.

In one embodiment, the potential energy storing device 50 is rotatably connected to the first wind turbine blade support 40 and the potential energy storing device 50 is fixedly mounted to the wind turbine tower 1 or to the upper support arrangement 30.

In one embodiment, the potential energy storing device 50 is connected to the first wind turbine blade support 40 with the second wind turbine generator part 62, and the potential energy storing device 50 is connected and to the wind turbine tower 10.

In one embodiment, the wind turbine 1 comprises a horizontal support 43, the first wind turbine blade support 40 is rotatably connected to the horizontal support 43, the horizontal support 43 is connected to the wind turbine tower 10 with the potential energy storing device 50.

In one embodiment, the potential energy storing device 50 comprises three or more the potential energy storing elements 53.

In one embodiment, the potential energy storing device 50 comprises three potential energy storing elements 53.

In one embodiment, the potential energy storing device 50 comprises three or more potential energy storing elements 53, the three or more potential energy storing elements 53 having a first end 51 and a second end 52, the first end 51 of the energy storing elements 53 is fixedly connected to wind tower 10 and second end 52 of the energy storing elements 53 is rotatably connected to the first wind turbine blade 20, and the first end 51 of the energy storing elements 53 being above the second end 52 of the energy storing elements 53.

In one embodiment, the potential energy storing device 50 comprises three potential energy storing elements 53, a horizontal angle A in a horizontal direction between the adjacent potential energy storing elements 53 being 120 degrees.

In one embodiment, the potential energy storing device 50 comprises three or more the potential energy storing elements 53, a horizontal angle A in a horizontal direction between the adjacent potential energy storing elements 53 being in the range of 0 and 120 degrees.

In one embodiment, the potential energy storing device 50 comprises three or more the potential energy storing elements 53, a horizontal angle A in a horizontal direction between the adjacent potential energy storing elements 53 being in the range of 10 and 120 degrees.

In the context of this application, a horizontal angle A in a horizontal direction between the adjacent potential energy storing elements 53 means a projection of an angle between the adjacent potential energy storing elements 53 on a horizontal plane, the horizontal plane being flat and level with the ground.

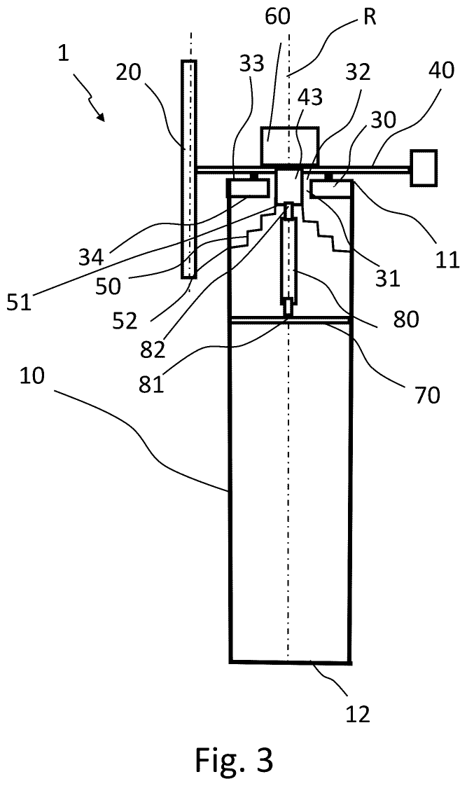

FIG. 3 shows schematically a side view of a wind turbine 1 according to one embodiment to the present invention.

In one embodiment, the wind turbine 1 comprises a horizontal support 43, the first wind turbine blade support 40 is rotatably connected to the horizontal support 43, the horizontal support 43 is connected to the wind turbine tower 10 with the potential energy storing device 50, the upper support arrangement 30 comprises an upper surface 33 and a lower surface 34, the upper surface 33 of the upper support arrangement 30 being above the lower surface 34 of the upper support arrangement 30, the upper support arrangement 30 comprises an upper support opening 32, the upper support opening 32 extending from the upper surface 33 of the upper support arrangement 30 to the lower surface 34 of the upper support arrangement 30, the horizontal support 43 extending through the upper support opening 32.

In one embodiment, the second wind turbine generator part 62 is fixed to the horizontal support 43.

In one embodiment, a wind turbine generator 60 comprises a wind turbine generator housing, the horizontal support 43 being the wind turbine generator housing and the second wind turbine generator part 62 is fixed to the wind turbine generator housing.

In one embodiment, the wind turbine 1 comprises a horizontal support 43, the first wind turbine blade support 40 is rotatably connected to the horizontal support 43, the horizontal support 43 is connected to the wind turbine tower 10 with the potential energy storing device 50, the upper support arrangement 30 comprises an upper surface 33 and a lower surface 34, the upper surface 33 of the upper support arrangement 30 being above the lower surface 34 of the upper support arrangement 30, the upper support arrangement 30 comprises an upper support opening 32, the upper support opening 32 extending from the upper surface 33 of the upper support arrangement 30 to the lower surface 34 of the upper support arrangement 30, the horizontal support 43 extending through the upper support opening 32.

In one embodiment, the wind turbine 1 comprises a horizontal support 43, the first wind turbine blade support 40 is rotatably connected to the horizontal support 43, the horizontal support 43 is connected to the wind turbine tower 10 with the potential energy storing device 50, the upper support arrangement 30 comprises an upper surface 33 and a lower surface 34, the upper surface 33 of the upper support arrangement 30 being above the lower surface 34 of the upper support arrangement 30, the upper support arrangement 30 comprises an upper support opening 32, the upper support opening 32 extending from the upper surface 33 of the upper support arrangement 30 to the lower surface 34 of the upper support arrangement 30, the horizontal support 43 extending through the upper support opening 32, the second wind turbine generator part 62 is fixedly connected to the horizontal support 43 and the first wind turbine generator part 61 is fixedly connected to the first wind turbine blade support 40, or to the first wind turbine blade support 40 and to the one or more second wind turbine blade support 440.

It should be noted that embodiments shown in FIGS. 1 and 2 may comprise the horizontal support 43 shown in FIG. 3.

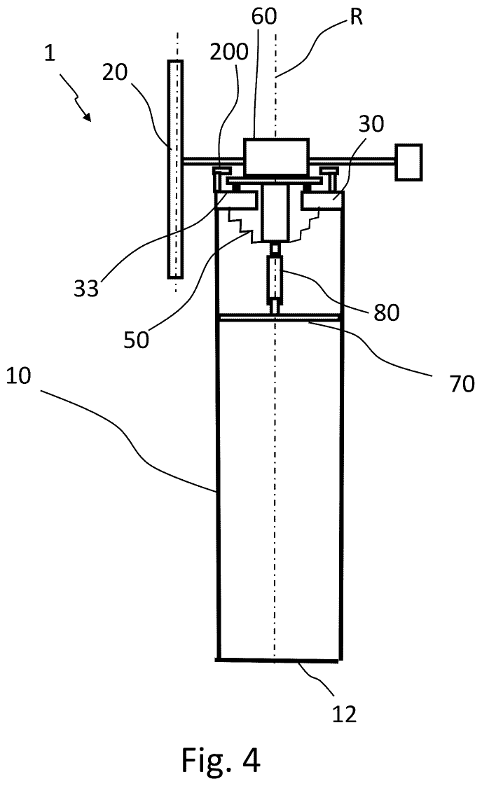

FIG. 4 shows schematically a side view of a wind turbine 1 according to one embodiment to the present invention.

In one embodiment, the potential energy storing device 50 is arranged to restrain a horizontal movement of the first wind turbine blade support 40 and a horizontal movement of the first wind turbine blade 20 and the potential energy storing device 50 is arranged further to restrain a vertical movement of the first wind turbine blade support 40 and the first wind turbine blade 20.

In one embodiment, the potential energy storing device 50 is arranged to restrain a horizontal movement of the first wind turbine blade support 40 and the first wind turbine blade 20 and the potential energy storing device 50 is arranged further to restrain a vertical movement of the first wind turbine blade support 40 and the first wind turbine blade 20, and the potential energy storing device 50 extending transverse relative to a horizontal direction and transverse relative to a vertical direction.

In one embodiment, the potential energy storing device 50 is arranged to restrain a horizontal movement of the first wind turbine blade support 40 and the first wind turbine blade 20 and the potential energy storing device 50 is arranged further to provide an upward vertical force to the first wind turbine blade support 40 or to the a wind turbine generator 60, and the first wind turbine blade 20, and the potential energy storing device 50 extending transverse relative to a horizontal direction and transverse relative to a vertical direction.

In one embodiment, the potential energy storing device 50 is arranged to restrain a horizontal movement of the first wind turbine blade support 40 and the first wind turbine blade 20, the potential energy storing device 50 is arranged further to provide an upward vertical force, and the first wind turbine blade 20, and the potential energy storing device 50 extending transverse relative to a horizontal direction and transverse relative to a vertical direction.

In one embodiment, the wind turbine tower 10 comprises a securing element 200 arranged to restrict a vertical movement of the first wind turbine blade support 40.

In one embodiment, the wind turbine tower 10 comprises a securing element 200 arranged to restrict a horizontal movement of the first wind turbine blade support 40.

In one embodiment, the wind turbine tower 10 comprises a securing element 200 arranged to restrict a vertical movement and a horizontal movement of the first wind turbine blade support 40.

In one embodiment, the wind turbine tower 10 comprises a securing element 200 arranged to restrict a vertical movement and a horizontal movement of the first wind turbine blade support 40, the securing element 200 is provided above the upper surface 33 of the upper support arrangement 30.

In one embodiment, the securing element is made of steel.

In one embodiment, the securing element is made of a steel plate or profile.

It should be noted that embodiments shown in FIGS. 1 and 2 may comprise the securing element 200 shown in FIG. 4.

It should be noted that embodiments shown in FIGS. 1 and 2 may comprise the potential energy storing device 50 is arranged further to provide a vertical force.

The present invention further relates to a use of a potential energy storing device 50 in a wind turbine 1 for restraining a horizontal movement of the first wind turbine blade support 40 and a horizontal movement of the first wind turbine blade 20 fixed to the first wind turbine blade support 40, characterized in that the first wind turbine blade 20 is arranged to move around a vertical axis R.

In one embodiment, the wind turbine 1 being any above disclosed embodiment of the wind turbine 1.

The invention has been described above with reference to the examples shown in the figures. However, the invention is in no way restricted to the above examples but may vary within the scope of the claims.

1. A wind turbine, wherein the wind turbine comprises:
a wind turbine tower, the wind turbine tower having an upper end and a lower end, and the wind turbine tower extending between the upper end of the wind turbine tower and the lower end of the wind turbine tower,
a first wind turbine blade, the first wind turbine blade is arranged to move around a vertical axis,
a first wind turbine blade support, the first wind turbine blade support extending between the first wind turbine blade and the wind turbine tower, and the first wind turbine blade is fixed to the first wind turbine blade support, or the first wind turbine blade is an integral part of the first wind turbine blade support,
an upper support arrangement provided to the wind turbine tower, the first wind turbine blade support is rotatably supported to the upper support arrangement, the upper support arrangement is arranged to provide the first wind turbine blade support with a support in a vertical direction,
an upper support gap arranged to enable a horizontal movement of the first wind turbine blade support in relative to the wind turbine tower, and
a potential energy storing device arranged to restrain a horizontal movement of the first wind turbine blade support and a horizontal movement of the first wind turbine blade.

2. A wind turbine according to claim 1, wherein:
the wind turbine further comprises a wind turbine generator comprising a first wind turbine generator part and a second wind turbine generator part, and the first wind turbine generator part is arranged to rotate relative to the second wind turbine generator part, and the first wind turbine generator part is arranged to move relative to the upper support arrangement; or
the wind turbine further comprises a wind turbine generator comprising a first wind turbine generator part and a second wind turbine generator part, the first wind turbine generator part is provided above the upper support arrangement, and the first wind turbine generator part is arranged to rotate relative to the second wind turbine generator part, and the first wind turbine generator part is arranged move in a horizontal direction relative to the upper support arrangement and the second wind turbine generator part is arranged to move in the horizontal direction together with the first wind turbine generator part; or
the wind turbine further comprises a wind turbine generator comprising a first wind turbine generator part and a second wind turbine generator part, the first wind turbine generator part is arranged to rotate relative to the second wind turbine generator part, and the first wind turbine generator part is arranged move in a horizontal direction relative to the upper support arrangement and the second wind turbine generator part is arranged to move in the horizontal direction together with the first wind turbine generator part.

3. A wind turbine according to claim 1, wherein:
the potential energy storing device is rotatably connected to the first wind turbine blade support and the potential energy storing device is mounted to the wind turbine tower; or
the potential energy storing device extending between the first wind turbine blade support (40) and the wind turbine tower, the potential energy storing device is rotatably connected to the first wind turbine blade support and the potential energy storing device is mounted to the wind turbine tower; or
the potential energy storing device is rotatably connected to the first wind turbine blade support and the potential energy storing device is fixedly mounted to the wind turbine tower or to the upper support arrangement; or
the potential energy storing device is connected to the first wind turbine blade support with the second wind turbine generator part, and the potential energy storing device is connected and to the wind turbine tower; or
the wind turbine comprises a horizontal support, the first wind turbine blade support is rotatably connected to the horizontal support, the horizontal support is connected to the wind turbine tower with the potential energy storing device.

4. A wind turbine according to claim 1, wherein:
the wind turbine comprises a wind turbine blade counterweight provided to the first wind turbine blade support; or
the blades of wind turbine consist of the first wind turbine blade; or
the wind turbine comprises a wind turbine blade counterweight provided to the first wind turbine blade support and the blades of wind turbine consist of the first wind turbine blade; or
the wind turbine comprises a wind turbine blade counterweight provided to the first wind turbine blade support, the first wind turbine blade support having a first end and a second end, the first wind turbine blade support extending between the first end and the second end, the first end of the first wind turbine blade support is provided at a first side of the wind turbine tower and the second end of the first wind turbine blade support is provided at a second side of the wind turbine tower, the first wind turbine blade is provided at a first side of the wind turbine tower and wind turbine blade counterweight is provided at a second side of the wind turbine tower; or
the wind turbine comprises a second wind turbine blade provided to the first wind turbine blade support, the first wind turbine blade support extending between the first wind turbine blade and the second wind turbine blade, and the first wind turbine blade support extending between the second wind turbine blade and the wind turbine tower; or
the wind turbine comprises one or more second wind turbine blade supports and one or more second wind turbine blades, the one or more second wind turbine blades are provided to the one or more second wind turbine blade supports, the one or more second wind turbine blade supports extending between the one or more second wind turbine blades and the wind turbine tower, the one or more second wind turbine blades are arranged to move around a vertical axis, and the one or more second wind turbine blade supports are supported in a vertical direction to the upper support arrangement.

5. A wind turbine according to claim 1, wherein:
the wind turbine comprises a universal joint, the universal joint is arranged to provide a rotational movement of the second wind turbine generator part relative to the first wind turbine generator part; or
the wind turbine comprises a lower support arrangement provided to the wind turbine tower below the upper support arrangement, the lower support arrangement being stationary relative to the wind turbine tower, the wind turbine comprises a universal joint, the universal joint having a lower end and an upper end, the lower end of the universal joint is mounted to the lower support arrangement and the upper end of the universal joint is connected to the second wind turbine generator part; or
the wind turbine comprises a lower support arrangement provided to the wind turbine tower below the upper support arrangement, the lower support arrangement being stationary relative to the wind turbine tower, the wind turbine comprises a universal joint, the universal joint having a lower end and an upper end, the lower end of the universal joint is mounted to the lower support arrangement and the upper end of the universal joint is mounted to the second wind turbine generator part, the universal joint is arranged to prevent a rotational movement of the second wind turbine generator part relative to the first wind turbine generator part; or
the wind turbine comprises a lower support arrangement provided to the wind turbine tower below the upper support arrangement, the lower support arrangement being stationary relative to the wind turbine tower, the wind turbine comprises a universal joint, the universal joint having a lower end (81) and an upper end, the lower end of the universal joint is mounted to the lower support arrangement or to the wind turbine tower, the upper end of the universal joint is mounted to a horizontal support, and the universal joint is arranged to provide a rotational movement of the second wind turbine generator part relative to the first wind turbine generator part.

6. A wind turbine according to claim 1, wherein:
the potential energy storing device comprises three or more the potential energy storing elements; or
the potential energy storing device comprises three potential energy storing elements; or
the potential energy storing device comprises three or more potential energy storing elements, the three or more potential energy storing elements having a first end and a second end, the first end of the energy storing elements is fixedly connected to wind turbine tower and second end of the potential energy storing elements is rotatably connected to the first wind turbine blade, and the first end of the energy storing elements being above the second end of the potential energy storing elements; or
the potential energy storing device comprises three potential energy storing elements, a horizontal angle in a horizontal direction between the adjacent potential energy storing elements being 120 degrees; or
the potential energy storing device comprises three or more the potential energy storing elements a horizontal angle in a horizontal direction between the adjacent potential energy storing elements being in the range of 0 and 120 degrees; or
the potential energy storing device comprises three or more the potential energy storing elements, a horizontal angle in a horizontal direction between the adjacent potential energy storing elements being in the range of 10 and 120 degrees.

7. A wind turbine according to claim 1, wherein:
the potential energy storing element comprises a pulley, a rope, and a weight; or
the potential energy storing element comprises a spring; or
the potential energy storing element comprises a tension spring; or
the potential energy storing element comprises a compression spring; or
the potential energy storing element comprises an elastic object; or
the potential energy storing element comprises a magnetic field; or
the potential energy storing element comprises a device filled with gas.

8. A wind turbine according to claim 1, wherein:
the potential energy storing device is arranged to restrain a horizontal movement of the first wind turbine blade support and a horizontal movement of the first wind turbine blade and the potential energy storing device is arranged further to restrain a vertical movement of the first wind turbine blade support and the first wind turbine blade; or
the potential energy storing device is arranged to restrain a horizontal movement of the first wind turbine blade support and the first wind turbine blade and the potential energy storing device is arranged further to restrain a vertical movement of the first wind turbine blade support and the first wind turbine blade, and the potential energy storing device extending transverse relative to a horizontal direction and transverse relative to a vertical direction; or
the potential energy storing device is arranged to restrain a horizontal movement of the first wind turbine blade support and the first wind turbine blade and the potential energy storing device is arranged further to provide an upward vertical force to the first wind turbine blade support or to the a wind turbine generator, and the first wind turbine blade, and the potential energy storing device extending transverse relative to a horizontal direction and transverse relative to a vertical direction; or
the potential energy storing device is arranged to restrain a horizontal movement of the first wind turbine blade support and the first wind turbine blade, the potential energy storing device is arranged further to provide an upward vertical force, and the first wind turbine blade, and the potential energy storing device extending transverse relative to a horizontal direction and transverse relative to a vertical direction.

9. A wind turbine according to claim 1, wherein:
the wind turbine tower comprises a lattice column; or
the wind turbine tower comprises a tubular column; or
the wind turbine tower comprises a lattice column and three or more guy-ropes; or
the wind turbine tower comprises a tubular column and three or more guy-ropes.

10. A wind turbine according to claim 1, wherein:
the upper support arrangement is provided to the upper end of the wind turbine tower or in the vicinity of the upper end of the wind turbine tower; or
the upper support arrangement is provided to the upper end of the wind turbine tower or in the vicinity of the upper end of the wind turbine tower, and the first wind turbine blade support is arranged to move above the upper end of the wind turbine tower and above the upper support arrangement; or
the upper support arrangement is provided to the upper end of the wind turbine tower or in the vicinity of the upper end of the wind turbine tower, and the first wind turbine blade support and the one or more second wind turbine blade supports are arranged to move above the upper end of the wind turbine tower and above the upper support arrangement.

11. A wind turbine according to claim 1, wherein:
the wind turbine comprises a friction reducing part between the first wind turbine blade support and the upper support arrangement, friction reducing part is arranged to reduce friction of a support of the first wind turbine blade support in a vertical direction; or
the wind turbine comprises a rolling bearing between the first wind turbine blade support and the upper support arrangement; or
the wind turbine comprises a rolling bearing between the first wind turbine blade support and the upper support arrangement, and the rolling bearing comprises one or more balls or rollers; or
the wind turbine comprises a rolling bearing between the first wind turbine blade support and the upper support arrangement, and the rolling bearing comprises three or more balls or rollers; or
the wind turbine comprises two sliding surfaces between the first wind turbine blade support and the upper support arrangement.

12. A wind turbine according to claim 1, wherein:
the wind turbine tower comprises a securing element arranged to restrict a vertical movement of the first wind turbine blade support; or
the wind turbine tower (10) comprises a securing element arranged to restrict a horizontal movement of the first wind turbine blade support; or
the wind turbine tower comprises a securing element arranged to restrict a vertical movement and a horizontal movement of the first wind turbine blade support; or
the wind turbine tower comprises a securing element arranged to restrict a vertical movement and a horizontal movement of the first wind turbine blade support, the securing element is provided above the upper surface of the upper support arrangement.

13. A wind turbine according to claim 1, wherein:
the wind turbine comprises the first wind turbine generator part, the first wind turbine blade support, the first wind turbine blade, and wind turbine blade counterweight arranged to move around a vertical axis, and a total weight of the first wind turbine generator part, the first wind turbine blade support, the first wind turbine blade and wind turbine blade counterweight being in the range of 400 kg-800 kg or 400-10 000 kg; or
the upper support gap being in the range of 10 mm-150 mm or in the range of 75 mm-150 mm or in the range of 5 mm-300 mm or more than 5 mm; or
the wind turbine comprises the first wind turbine generator part, the first wind turbine blade support, the first wind turbine blade, and wind turbine blade counterweight arranged to move around a vertical axis, and a total weight of the first wind turbine generator part, the first wind turbine blade support, the first wind turbine blade and wind turbine blade counterweight being in the range of 400 kg-800 kg or 400-10 000 kg, and the upper support gap being in the range of 10 mm-150 mm or in the range of 75 mm-150 mm or in the range of 5 mm-300 mm or more than 5 mm.

14. A wind turbine according to claim 1, wherein:
the wind turbine comprises a horizontal support, the first wind turbine blade support is rotatably connected to the horizontal support, the horizontal support is connected to the wind turbine tower with the potential energy storing device, the upper support arrangement comprises an upper surface and a lower surface, the upper surface of the upper support arrangement being above the lower surface of the upper support arrangement, the upper support arrangement comprises an upper support opening, the upper support opening extending from the upper surface of the upper support arrangement to the lower surface of the upper support arrangement, the horizontal support extending through the upper support opening; or
the wind turbine comprises a horizontal support, the first wind turbine blade support is rotatably connected to the horizontal support, the horizontal support is connected to the wind turbine tower with the potential energy storing device, the upper support arrangement comprises an upper surface and a lower surface, the upper surface of the upper support arrangement being above the lower surface of the upper support arrangement, the upper support arrangement comprises an upper support opening, the upper support opening extending from the upper surface of the upper support arrangement to the lower surface of the upper support arrangement, the horizontal support extending through the upper support opening, the second wind turbine generator part is fixedly connected to the horizontal support and the first wind turbine generator part is fixedly connected to the first wind turbine blade support, or to the first wind turbine blade support and to the one or more second wind turbine blade support.

15. Use of a potential energy storing device in a wind turbine for restraining a horizontal movement of the first wind turbine blade support and a horizontal movement of the first wind turbine blade fixed to the first wind turbine blade support, wherein the first wind turbine blade is arranged to move around a vertical axis.

16. Use according to claim 15, wherein the wind turbine being a wind turbine wherein the wind turbine comprises:
a wind turbine tower, the wind turbine tower having an upper end and a lower end, and the wind turbine tower extending between the upper end) of the wind turbine tower and the lower end of the wind turbine tower,
a first wind turbine blade, the first wind turbine blade is arranged to move around a vertical axis,
a first wind turbine blade support, the first wind turbine blade support extending between the first wind turbine blade and the wind turbine tower, and the first wind turbine blade is fixed to the first wind turbine blade support, or the first wind turbine blade is an integral part of the first wind turbine blade support,
an upper support arrangement provided to the wind turbine tower, the first wind turbine blade support is rotatably supported to the upper support arrangement, the upper support arrangement is arranged to provide the first wind turbine blade support with a support in a vertical direction,
an upper support gap arranged to enable a horizontal movement of the first wind turbine blade support in relative to the wind turbine tower, and
a potential energy storing device arranged to restrain a horizontal movement of the first wind turbine blade support and a horizontal movement of the first wind turbine blade.
